(19) United States
(12) Patent Application Publication
(10) Pub. No.: US 2004/0046892 A1
(43) Pub. Date: Mar. 11, 2004

(54) Method and associated device for storing teletext sub-pages

(76) Inventors: Thierry Crespo, Trets (FR); Arnaud Albella, Aix en Provence (FR)

Correspondence Address: Christopher F Regan, Allen Dyer Doppelt Milbrath & Gilchrist, P O Box 3791, Orlando, FL, 32802-3791, US

(21) Appl. No.: 10/451,181

(22) PCT Filed: Dec. 13, 2001
(86) PCT No.: PCT/FR01/03972

(30) Foreign Application Priority Data
Dec. 5, 2001 (FR) 01/15706

(51) Int. Cl. H04N 7/00; H04N 11/00

(52) U.S. Cl. 348/468; 348/714; 348/553

(57) ABSTRACT

A method for the storage of sub-pages of a teletext service comprises a page (Y0) to be stored, said page (Y0) to be stored comprising at least one sub-page. A desired sub-page is stored (E2, E4) and, as the case may be, sub-pages neighboring the desired sub-page are stored (E5) until a maximum number of stored sub-pages (MAXY0) is reached or until a limit number (NB_LIMY0) of sub-pages of the page to be stored is reached. In one example, the desired sub-page is the rank 1 sub-page of the page to be stored, and the neighboring sub-pages, if any, are the following sub-pages. A user thus has direct access to the start of the information contained in the page to be stored. In another example, the desired page is a rank X0 sub-page requested by a user, and the sub-pages neighboring the desired sub-pages are pages with ranks 1, X0+1, X0−1, etc.

### BACKGROUND OF THE INVENTION

1. Field of the Invention

An object of the invention is a method and an associated device for the storage of teletext sub-pages and a television receiver implementing said storage method. The present invention relates more particularly to the field of teletext as defined in the ETS (Enhanced Teletext Specification) No. 300 706 updated in May 1997.

Teletext is an ancillary service of television stations designed for the transmission, in addition to video information, of written information in the form of digital data. A full teletext service of a television station can be subdivided into a variable number of pages (ranging from 100 to 899 according to the ETS standard)

Each page can itself be subdivided into one or more sub-pages (0 to 79 according to the ETS standard). All the sub-pages of one and the same page form a consistent whole in terms of informational content which it is preferable to consult in chronological order, starting from the first sub-page. A full service of a television station may thus comprise up to 71,000 sub-pages approximately and the whole service is broadcast constantly and cyclically but not necessarily in chronological order. Each sub-page is thus broadcast approximately every 40 seconds.

The digital data in a sub-page are assembled in the form of data packets. One of the packets, often called a header packet, comprises especially references of the sub-page to which it is attached. These references are for example in the form “sub-page 5 of page 54”, indicating the number or rank of the page (5) and the number of the page to which it belongs (54).

2. Description of the Prior Art

In existing navigation systems, which help a user of a teletext service to identify the page that concerns him more or less easily, the choice of a page is made for example by indicating the number of the page requested. The movement between the different sub-pages of one and the same page is then done by “previous sub-page”/“next sub-page” type commands or else directly by specifying the number of the sub-page.

In a television receiver, a device dedicated to the teletext service comprises, according to FIG. 1, a decoder 11, a data memory 12, a display memory 13 and a display means 14.

The decoder 11 receives the digital data pertaining to the sub-pages of the service and stores some of them in the data memory 12. When the user requests the display of a sub-page on a screen of the television receiver, the decoder 11 copies the requested sub-page from the data memory 12 in the display memory 13. Finally, a display means 14 continually reads the contents of the display memory 14 and copies them on a screen 15 of the television receiver.

If the requested sub-page is already stored in the data memory 12, then it is immediately displayed. If not, it takes much longer for the display to be made because the decoder 11 must first of all receive and then store the requested sub-page in the memory 12.

The number of sub-pages stored depends essentially on the size of the data memory 12, which is highly variable from one device to another. The number of sub-pages stored also depends on the volume of digital data pertaining to each sub-page which may vary from one sub-page to another.

The number of sub-pages that can be stored is, for example, in the range of 10 to 15. This is a compromise between, firstly, the mean display time of a requested page which diminishes when the number of pages stored increases and, secondly, the cost of the device which greatly increases with the size of the data memory 12.

The number of sub-pages stored is therefore limited as compared with the total number of sub-pages or pages of a teletext service. The decoder 11 manages the contents of the memory 12 as a function of the sub-pages broadcast continually by the transmitter station and of the user's requests. These are real or estimated requests. They are estimated especially from the sub-pages being displayed if a sub-page is being displayed.

Most frequently, the decoder 11 stores the sub-pages as and when they are received. If the memory 12 is full, then the decoder 11 continues to store the sub-pages as and when they are received, by erasing the previously stored sub-pages. Since only about 10 sub-pages are stored in the present example, the probability of the sub-page being present in the memory when the user requests its display is low. Consequently, the mean display time for a teletext service sub-page is great.

The mean display time of the sub-page can be reduced by storing a limited number of pages of the service and by storing one or two sub-pages per page. The mean display time is diminished but remains substantial because a page may contain a number of sub-pages that varies between one and 80.

Furthermore, the order in which the sub-pages of the service are broadcast as well at the total number of sub-pages broadcast vary as a function of the day of the broadcast, the transmitter station etc. Furthermore, if the device is activated during the broadcasting of a teletext service, the first pages of the service are received not immediately but only during the next broadcasting cycle. Finally, it is difficult to foresee the sub-page that will be contained in the memory 12 at a given point in time.

For all these reasons, when the user requests the display of a sub-page of a service, the probability that this sub-page will be already stored is low. Similarly, when the user requests the display of a page comprising sub-pages, the probability that the first-ranking sub-page will be stored is low. However, the sub-page 1 corresponds to the start of the information contained in the page.

Consequently, with known devices and methods, the mean time of display of a sub-page is relatively lengthy. Furthermore, it is improbable that the beginning of the information will be directly accessed during the display of a page. All this greatly limits the value of known devices and of the teletext service for the user.

### SUMMARY OF THE INVENTION

It is a goal of the invention to reduce the mean display time of the sub-page by increasing the probability of the sub-page being already present in the memory when the user requests it.

Another object of the invention is to enable the user to directly access the beginning of the information pertaining to a teletext page.

With these goals in view, the invention relates to a method for the storage of sub-pages of a teletext service comprising at least one page to be stored, said page to be stored comprising at least one sub-page, wherein:

a desired sub-page is stored, and

as the case may be, sub-pages neighboring the desired sub-page are stored until a maximum number of stored sub-pages is reached or until a limit number of sub-pages of the page to be stored is reached.

The maximum number of sub-pages stored is defined by the user or manufacturer of a television receiver using the method of the invention. In practice, this number is directly related to the size of the data memory used to store the pages of sub-pages. This number for example is in the range of 2 to 3 if the size of the data memory is sufficient to store 10 to 15 pages of sub-pages.

The limit number of sub-pages for a page is the total number of sub-pages of one and the same page. It is variable and fixed by the television station.

Furthermore, the expression “the neighboring sub-page” and more generally the expressions “neighboring page”, “nearby page”, “near” “close” etc. must be understood herein as follows: A page A is said to be neighboring (or near) a page B if, when the page B is displayed, there is a high probability that the user will requests the display of the page A after having looked at the page B.

For example, the sub-pages ranked A+1 or A−1 are close to the sub-page ranked A because the sub-pages of one and the same page are most usually gone through in chronological order, by virtue of their vary character of being sub-pages.

In the same spirit, the first-ranking sub-pages of all the pages of the service are close to a higher-ranking sub-page and to anyone of the pages of the service.

Thus, with the method of the invention, when a page is stored, its sub-pages are stored only if they are near a desired sub-page of said page to be stored. There is therefore a high probability that, if a user requests the display of a sub-page, this sub-page will already be stored. In this case, the display is immediate. Thus, with the invention, the mean display time is diminished as compared with known methods of storage.

According to one embodiment of the method of the invention, the desired sub-page is a rank 1 sub-page of the page to be stored, and the sub-pages neighboring the desired sub-page are the pages with ranks closest to one.

Thus, when the user requests the display of a teletext page, the rank 1 sub-pages immediately displayed. This rank 1 sub-page corresponds to the beginning of the information contained in the page, and the page may contain several sub-pages.

In this embodiment, the method is advantageously implemented by performing the following steps:

E1: the initialization of a counter to count the number of sub-pages stored,

E2: the storage of the rank 1 sub-page of the page to be stored, and the updating of the counter,

E5: the storage of sub-pages neighboring the desired sub-page and the updating of the counter, the step E5 being repeated until the counter has reached a maximum number of stored sub-pages.

The step E5 comprises for example the following sub-steps:

E50: the initialization of a positive loop variable,

E52: the storage of the sub-page with a rank equal to the positive loop variable, and the updating of the counter and of the positive loop variable, the step 52 being repeated until the maximum number of stored sub-pages is reached or until the limit number of sub-pages of the page to be stored is reached.

This embodiment is for example used if the user has not (yet) requested the display of a page. In this case, for the page to be stored, the rank 1 sub-page (the desired sub-page), and the pages ranked 2,3 etc close to the rank 1 sub-page are stored. The user thus has very easy and immediate access to the information contained in the page to be stored.

This embodiment may be chosen for example as a default embodiment and may be used especially when no sub-page in particular is requested by the user during the request for the display of a page.

According to another embodiment, the desired sub-page is a rank X0 sub-page requested by a user, and the sub-pages neighboring the desired sub-pages are pages immediately preceding the desired sub-page and/or sub-pages immediately following the desired sub-page.

In this case, apart from the steps E1, E2, E5, the following step E4 is carried out. It is executed before or after the step E2:

E4: the storage of an X0 ranking desired sub-page of the page to be stored, and the updating of the counter.

The step E5 is furthermore complemented by the step E55, performed after or before the sub-step E52.

E55: if the negative loop variable is greater than 0, then the storage of the sub-page with a rank equal to the negative loop variable, followed by the updating of the counter and the negative loop variable.

This embodiment is used for example when the X0 ranking sub-page (the desired sub-page) of a page y0 (the page to be stored) is being displayed at the user's request. In this case, the sub-pages ranked X0, 1, X0+1, X0−1, etc are stored.

This is useful to the user owing to the very fact of the structure of a page and of a teletext sub-page: the set of sub-pages of one and the same page forms a consistent whole and the informational content of the set must be read in the chronological order of the sub-pages in order to be comprehensible. With the invention, after having displayed the sub-page X0, the user has very immediate and easy access to the neighboring pages X0+1, X0−1, etc.

According to another embodiment, the teletext service comprises several pages to be stored, each page comprising at least one sub-page. For each page to be stored, a desired sub-page is stored. This is either a rank 1 sub-page or a rank X0 sub-page requested by the user. Furthermore, for each page to be stored, sub-pages neighboring the desired sub-page are stored until a maximum number of stored sub-pages of the page to be stored is reached or until a limit number of sub-pages of the page to be stored is reached.

It may be recalled that the maximum number of sub-pages stored is defined by the user or the manufacturer of a television receiver using the method of the invention. In practice, the number is directly related to the size of the data memory used to store the page of sub-pages. This number is for example in the range of two to three if the size of the data memory is sufficient to store 10 to 15 pages or sub-pages.

The limit number of sub-pages for a page is the total number of sub-pages of one and the same page. It is variable.

The invention also relates to a storage device comprising a data memory to store a teletext page comprising at least one sub-page, wherein the circuit comprises a decoder laid out to implement a method as described here above.

Finally, the invention also relates to a television receiver comprising a storage device such as the one described here above.

### BRIEF DESCRIPTION OF THE DRAWINGS

The invention will be understood more clearly and other features and advantages will appear from the following description of an exemplary embodiment of the method and associated device of the invention. The description refers to be appended figures, of which:

FIG. 1 which has already been described is a functional diagram of the device dedicated to the teletext service, according to the prior art, and

FIGS. 2 and 3 are diagrams of algorithms for the implementation of a storage method according to the invention.

### MORE DETAILED DESCRIPTION

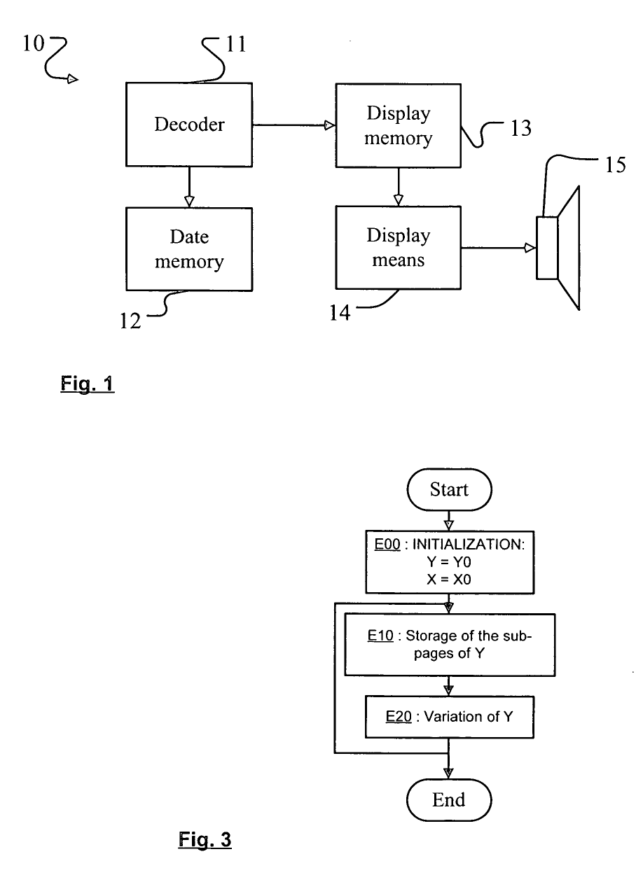

The storage method according to the invention is implemented in a device dedicated to a teletext service similar to a known device such as the one shown in FIG. 1. It has, in particular, a data memory 12, a display memory 13 and a display means 14 identical to those of the known prior art and connected similarly.

The device also has a novel decoder laid out to implement the method for the storage of teletext sub-pages according to the invention.

In the first exemplary implementation of the method, it is assumed that the sub-page X0 of the page Y0 of the broadcast teletext service is requested by a user and must therefore be stored. It is also assumed that it is planned to store, at best, a number MAXY0 of sub-pages of the page Y0, among them the rank 1 sub-page, the rank X0 sub-page and sub-pages neighboring the sub-page X0. The user fixes X0, Y0.

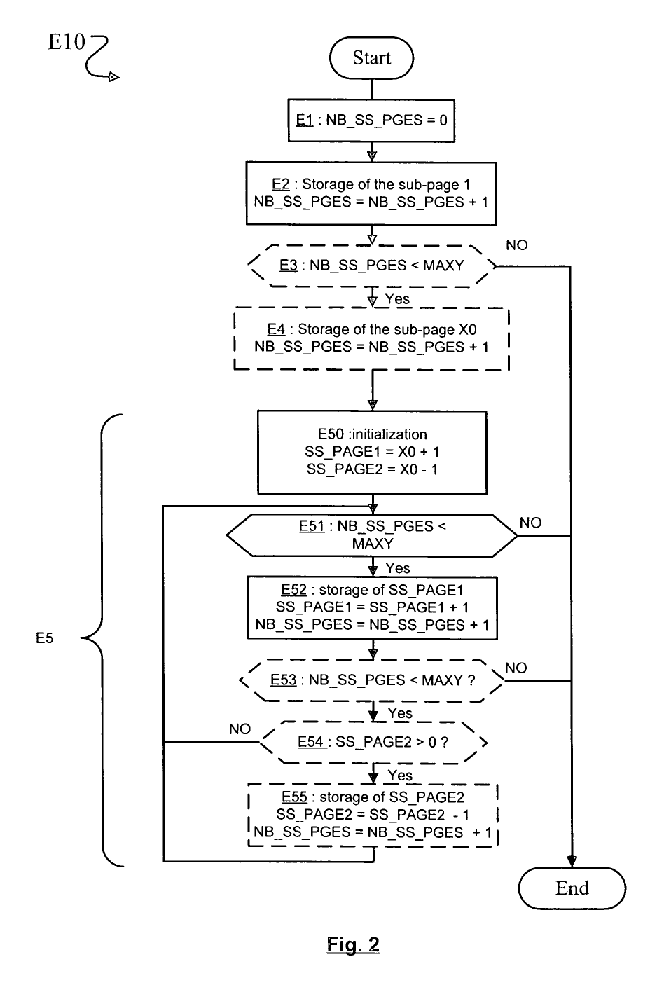

For this first example, the steps of the method are presented in FIG. 2.

During a step E1, a variable NB_SS_PGES is initialized at 0; this variable is used to count the number of stored sub-pages and verify that this number does not exceed the number MAXY0.

During a step E2, the rank 1 sub-page of page Y0 is stored and the variable NB_SS_PGES is updated: NB_SS_PGES=NB_SS_PGES+1.

Then, during a step E3, a test is performed to verify whether the number of sub-pages already stored has not reached its limit value MAXY0. If the value MAXY0 has been reached, then the procedure is terminated. If not, the steps E4, E5 are carried out.

During the next step E4, the rank X0 sub-page is stored and the variable NB_SS_PGES is updated: NB_SS_PGES=NB_SS_PGES+1.

A step E5 is then carried out, to store the sub-pages neighboring the sub-page X0. The step E5 can be subdivided as follows:

During the step E50, two loop variables are initialized:

SS_PAGE=X0+1

SS_PAGE=X0−1

The variable SS_PAGE 1 is used to access the sub-pages following the sub-page in progress: X0+1, X0+2, etc. The variable SS_PAGE2 is used in the same way for the sub-pages preceding the current sub-page X0−1, X0−2 etc.

During a following step E51, another test is performed to verify whether the number of sub-pages already stored has not reached its limit value MAXY0. If the value MAXY0 is reached, then the step E5 is terminated. If not, a step E52 is carried out.

During the step E52, the SS_PAGE1 ranking sub-page is stored and the variables SS_PAGE1 and NB_SS_PGES are updated:

SS_PAGE1=SS_PAGE1+1

NB_SS_PGES=NB_SS_PGES+1.

During a following step E53, which is identical to the step E51, a test is performed. If the maximum number MAXY0 of sub-pages to be stored is reached (negative test), then the step E5 is terminated. If not, a step E54 is carried out.

During the test E54, it is verified whether the loop variable SS_PAGE2 is positive. If the test is negative, then another step 51 is carried out. If not, a step E55 is carried out.

During the step E55, the SS_PAGE2 ranking sub-page is stored and the variables SS_PAGE2 and NB_SS_PGES are updated:

SS_PAGE2=SS_PAGE2−1

NB_SS_PGES=NB_SS_PGES+1.

At the end of the step E55, a new step E51 is carried out.

The method of FIG. 2 is terminated when the number of sub-pages stored has reached its maximum value MAXY0 (when one of the tests E3, E51 or E53 is negative).

The method of FIG. 2 is interrupted and then carried out another time if the user requests the display of a new page or sub-page.

In this example, the rank 1 sub-pages, X0+1, X0−1, X0+2, X0−2 etc. are stored until the maximum number MAXY0 of sub-pages to be stored is reached. The order in which the sub-pages are stored depends especially on the order in which the sub-pages are received by the decoder. The order in which the sub-pages are stored is furthermore immaterial when the method of the invention is being carried out. It may be modified, by exchanging the steps E2 and E4, or else by performing the step E50 twice in succession, and then the step E55 twice for example. What is essential is to store the sub-page X0, the sub-page 1 and the sub-pages neighboring the sub-page X0.

The rank X0 sub-page of page Y0 is displayed in parallel, since it is requested by the user. If the user then wishes to have the rest of the page Y0 that he is consulting, the display of the next sub-page X0+1 will be immediate since it is already stored. If, on the contrary, the user wishes to access the beginning of the information contained in the page Y0, he will have very easy access to the sub-page 1 of the page Y0 since the sub-page 1 has been previously stored.

In a second exemplary implementation of the method of the invention, it is assumed that the sub-pages of the page Y0 of a teletext service must be stored although the user has not requested the display of the page Y0 or of one of its sub-pages (for example the user has requested the display of a page neighboring the page Y0 or else no page is displayed). It is furthermore assumed that it is planned to store, at best, a number MAXY0 of sub-pages of page Y0. In this case, it is chosen to store the sub-page 1 of the page Y0 and the sub-pages neighboring the sub-page 1.

In this example, the user has immediate access to the sub-page 1 of the page Y0 if he has requested its display and the sub-pages 2,3, 4 etc. are available. The user thus has direct access to the beginning of the information contained in the page Y0 and he can consult the sub-pages of the page Y0 in chronological order.

For this example, the method of FIG. 2 is modified as follows:

the steps E3 any 4 are eliminated, the step E5 in this case is performed after the step E2. This elimination is warranted because the sub-step 1 is already stored during the step E2.

the step E50 is modified as follows:

SS_PAGE1=2

SS_PAGE2=0

the steps E53, E54, E55 are eliminated because they are unnecessary. This is warranted by the fact that there is no negative ranking sub-page.

In a third exemplary implementation of the method of the invention, it is assumed that:

the sub-page X0 of the page Y0 is requested by the user, and it must be stored in order to be displayed

the pages X0+1, X0−1, etc neighboring the sub-page X0 must be stored.

the pages Y0+1, Y0−1 neighboring Y0 must also be stored. To this end, for each page neighboring the page Y0, the sub-pages 1,2,3 etc must be stored.

The user thus has very fast access to the pages or sub-pages closest to the sub-page that he has requested on the screen.

For this third example, the method of FIG. 3 is carried out.

During a step E00, variables of pages and sub-pages are initialized: X=X0 and Y=Y0.

During the following step E10, a step E10 for the storage of sub-pages of the page Y=Y0 is carried out. The step E10 comprises the set of steps E1 to E5 of the diagram of FIG. 2, and the step E50 is simply modified as follows:

SS_PAGE1=X+1

SS_PAGE2=X−1

During the next step E20, the variable Y is updated: Y=Y0+1. Then a new step E10 is performed to store the sub-pages of the page Y=Y0+1.

The steps E10, E20 are repeated until all the pages and all their desired sub-pages are stored and/or until the data memory is saturated.

During the first execution of the step E11, the page Y0 is stored, especially its rank 1 and rank X0 sub-pages, and the sub-pages neighboring the rank X0 sub-page. During each following execution of the step E10, a page neighboring the page Y0 is stored, especially the sub-pages 1,2,3 etc of the page neighboring the page Y0.

The method is interrupted and then executed again if the user requests the display of a new page or a new sub-page.

Choice of pages to be stored:

In the third example (FIG. 3), the page Y0 and its neighboring pages Y0+1, Y0−1,Y0+2, Y0−2 are stored with their respective sub-pages.

However, it is possible to store other pages neighboring the page Y0, for example the pages corresponding to blocks or groups of pages as defined in the ETS standard, when a TOP navigation system is used. For this purpose, it is enough to modify the step E20 accordingly to give the desired values to the variable Y. For example, if Y0=125, Y may successively assume the values 100, 200, 300 etc., Y being modified at each execution of the step E20.

It is also possible to define a priority number for each service page. This priority number is for example variable as a function of the sub-page X0 of the page Y0 requested by the user. A page or a sub-page has high priority if it is close to the page X0. Conversely, a page or a sub-page has low priority if it is distant from the sub-page X0.

Value of the number MAXY:

In the above examples, the number MAXY of sub-pages is considered to be constant. However, it is possible to consider the storage of a number of sub-pages that is variable as a function of the stored page. It is enough, for this purpose, to modify the step E1 to add an initialization of the number MAXY as a function of the value of Y.

Stopping the step E5:

In the above examples given with reference to FIGS. 2, 3, it has been implicitly assumed that one and the same page comprises a number of sub-pages NB_LIMY greater than the chosen number MAXY. However, this is not necessarily the case. For example, certain service pages may comprise a reduced number NB_LIMY of sub-pages, even just one sub-page.

In this case, the method is advantageously improved by adding a complementary step E51′, between the steps E51 and E52, to test whether the variable SS_PAGE1 is smaller than the number NB_LIMY of the page Y being stored. If SS_PAGE1 is smaller than NB_LIMY, then the step E52 is carried out. If not, the step E54 is carried out. NB_LIMY corresponds to the number of existing sub-pages for one and the same given page Y.

Just like the number MAXY, the number NB_LIMY may be variable from one page Y to another. In this case, it is preferably initialized during the step E1.

Other modifications and/or improvements may be envisaged, the essential point being that the following requirements should be complied with:

if the display of a sub-page X0 of a page Y0 is requested by the television viewer, then storage of the rank X0 sub-page, the rank 1 sub-page, and sub-pages having ranks in the neighborhood of X0, within the limit of a maximum number NB_SS_PGES=MAX(Y0) of sub-pages stored for the page Y0 and/or within the limit of the number of sub-pages NB_LIM of page Y0.

if no sub-page of the page Y0 is requested, then storage of the rank 1 sub-page and sub-pages having ranks in the vicinity of 1 within the limit of a maximum number of pages NB_SS_PGES=MAX(Y0) of sub-pages stored for the page Y0 and/or within the limit of the number of sub-pages of the page Y0.

What is claimed is:

1. A method for the storage of sub-pages of a teletext service comprising at least one page (Y0) to be stored, said page (Y0) to be stored comprising at least one sub-page, wherein:
a desired sub-page is stored (E2, E4), and
as the case may be, sub-pages neighboring the desired sub-page are stored (E5) until a maximum number of stored sub-pages (MAXY0) is reached or until a limit number (NB_LIMY0) of sub-pages of the page to be stored is reached.

2. A method according to claim 1, wherein the desired sub-page is a rank 1 sub-page of the page (Y0) to be stored, and the sub-pages neighboring the desired sub-page are the sub-pages with ranks closest to one.

3. A method according to claim 1, wherein the desired sub-page is a rank X0 sub-page requested by a user, and the sub-pages neighboring the desired sub-pages are pages (X0−1, X0−2, . . . ) immediately preceding the desired sub-page and/or sub-pages (X0+1, X0+2, . . . ) immediately following the desired sub-page.

4. A method according to one of the claims 1 to 3, wherein:
the teletext service comprises several pages to be stored, each page comprising at least one sub-page,
for each page to be stored, a desired sub-page is stored, this sub-page being either a rank 1 sub-page or a sub-page requested by the user,
for each page to be stored, sub-pages neighboring the desired sub-page are stored until a maximum number of stored sub-pages (MAXY0) of the page to be stored is reached or until a limit number (NB_LIMY0) of sub-pages of the page to be stored is reached.

5. A method according to claim 4, wherein the pages to be stored are pages close to the desired page.

6. A method according to claim 4, wherein two pages to be stored have different limit numbers NB_LIMY of sub-pages.

7. A method according to claim 4, wherein two pages to be stored have different maximum numbers (MAXY) of stored sub-pages.

8. A method according to claim 1, wherein, to store the page (Y0) to be stored, the following steps are carried out:
E1: the initialization of a counter (NB_SS_PGES=0) to count the number of sub-pages stored,
E2: the storage of a rank 1 sub-page of the page (Y0) to be stored, and the updating of the counter (NB_SS_PGES=NB_SS_PGES+1),
E4 the storage of a desired rank X0 sub-page of the page (Y0) to be stored, and the updating of the counter (NB_SS_PGES=NB_SS_PGES+1), the step E4 being carried out only if the rank X0 of the desired page is different from 1, and
E5: the storage of sub-pages neighboring the desired rank X0 sub-page and the updating of the counter, the step E5 being repeated until the counter has reached a maximum number of stored sub-pages (MAXY0).

9. A method according to claim 8, wherein the step E5 comprises sub-steps E50 to E55 as follows:
E50: the initialization of a positive loop variable (SS_PAGE1=X0 or 1) and of a negative loop variable (SS_PAGE2=X0 or 1),
E52: the storage of the sub-page with a rank equal to the positive loop variable, and the updating of the counter and of the positive loop variable
E55: if the negative loop variable is greater than 0, then the storage of the sub-page with a rank equal to the negative loop variable, followed by the updating of the counter and the negative loop variable.

10. A storage device (10) comprising a data memory (12) to store a teletext page comprising at least one sub-page, wherein the circuit comprises a decoder (11) laid out to implement a method according to one of the claims 1 to 9

11. A television receiver comprising a storage device according to claim 10.
